(19) United States
(12) Patent Application Publication
(10) Pub. No.: US 2026/0061888 A1
(43) Pub. Date: Mar. 5, 2026

(54) AUTOMATIC BATTERY CONNECTION SWITCHING

(71) Applicant: CPS Technology Holdings LLC, New York, NY (US)

(72) Inventors: Jason David SEARL, Bayside, WI (US); John P. BANIA, Whitefish Bay, WI (US)

(21) Appl. No.: 19/105,458

(22) PCT Filed: Aug. 24, 2023
(86) PCT No.: PCT/US2023/072794

§ 371 Date: Feb. 21, 2025

Related U.S. Application Data
(60) Provisional application No. 63/400,567, filed on Aug. 24, 2022.

(51) Int. Cl. B60L 58/19; B60L 1/08; B60L 3/00

(52) U.S. Cl. CPC B60L 58/19; B60L 1/08; B60L 3/0046; B60L 2240/545; B60L 2240/547; B60L 2240/549; B60L 2260/54; B60L 2270/12

(57) ABSTRACT

A method, system (10) and apparatus are disclosed. A CMU (16) is described. The CMU (16) is electrically connectable to a plurality of energy storage units (14) configurable to provide power to a vehicle (12) including an exhaust. The CMU (16) is configured to determine a connection arrangement of two or more energy storage units (14) of the plurality of energy storage units (14) based on at least one parameter. The connection arrangement includes at least one connection type between the two or more energy storage units (14). The at least one parameter includes a temperature associated with the exhaust of the vehicle (12). The CMU (16) is further configured to cause the two or more energy storage units (14) to provide power to the vehicle (12) using the determined connection arrangement.

### TECHNICAL FIELD

The present disclosure relates to energy storage systems, and in particular, to automatic arrangement and/or switching of battery connections.

### BACKGROUND

Motor-powered and/or electrically powered vehicles rely on using one or more battery systems for providing a starting power and/or at least a portion of a motion power for the vehicle and/or power for pre-start heaters. Such vehicles may include one or more of an air- or watercraft, a rail-guided vehicle, a street vehicle, etc., where a street vehicle may refer to, for example, one or more cars, trucks, buses, recreational vehicles, etc.

In vehicles, different batteries may be used, such as pre-start batteries and starter batteries. A pre-start battery may be arranged to provide power for pre-start systems that require exceeding a temperature threshold prior to engine start such as electric catalyst heater systems in commercial trucks. A starter battery may be used for providing the energy/power for starting/operating a vehicle, e.g., after completing pre-start heating.

Typically, pre-start systems such as electric catalyst heaters demand voltages (e.g., 48V) that are higher than the voltage (e.g., 12V) provided by the starter battery, thereby requiring the pre-start batteries and the starter batteries to be in the vehicle to power the electric catalyst heater(s) and to start the vehicle, respectively. However, having vehicles with both pre-start batteries and starter batteries adds undesirable weight to the vehicle and additional maintenance, thereby making the vehicle less efficient and more costly to operate, when compared to vehicles that use a single battery or set of batteries such as starter batteries.

### SUMMARY

Some embodiments advantageously provide methods, systems, and apparatuses for automatic switching of battery connections. In some embodiments, a single set of batteries (e.g., start batteries) may be arranged to meet the demands of pre-starting (e.g., pre-heat) and starting/operating a vehicle by switching to a connection arrangement to provide power for pre-start and/or switching to another connection arrangement to provide power for starting/operating the vehicle. In one or more embodiments, a connection management unit (CMU) is configured to determine a connection arrangement (e.g., a series connection, a parallel connection) of two or more energy storage units and/or cause the two or more energy storage units to be connected using the determined connection arrangement. In one nonlimiting example, four energy storage units (e.g., batteries) may be connected in parallel. e.g., to provide power to a load such as a truck engine/system, and/or be connected (i.e., switch from the parallel connection to be connected) in series, e.g., to provide power to another load such as a heater that uses a higher voltage. The series connection may also be switched to the parallel connection such as to provide power for operation of the truck engine/system.

According to one aspect, a CMU is described. The CMU is electrically connectable to a plurality of energy storage units configurable to provide power to a vehicle including an exhaust. The CMU is configured to determine a connection arrangement of two or more energy storage units of the plurality of energy storage units based on at least one parameter. The connection arrangement includes at least one connection type between the two or more energy storage units. The at least one parameter includes a temperature associated with the exhaust of the vehicle. The CMU is further configured to cause the two or more energy storage units to provide power to the vehicle using the determined connection arrangement.

According to another aspect. A CMU is described. The CMU is electrically connectable to a plurality of energy storage units configurable to provide power to a vehicle including an exhaust. The CMU is configured to determine a connection arrangement of two or more energy storage units of the plurality of energy storage units based on at least one parameter. The connection arrangement includes at least one connection type between the two or more energy storage units. The at least one parameter includes a temperature associated with the exhaust of the vehicle. The connection arrangement includes one of a first connection arrangement and a second connection arrangement. The first connection arrangement includes a first connection type. The second connection arrangement includes a second connection type. Further, determining the connection arrangement includes one of switching from the first connection arrangement to the second connection arrangement based on the at least one parameter and switching from the second connection arrangement to the first connection arrangement based on the at least one parameter. In addition, the CMU is further configured to cause the two or more energy storage units to one of provide power and terminate providing power to the vehicle using the determined connection arrangement.

According to one aspect, a system is described. The system includes a CMU and a plurality of energy storage units. The CMU includes at least one switch electrically connectable to at least one of the plurality of energy storage units. The CMU is electrically connectable to the plurality of energy storage units. The plurality of energy storage units is electrically connectable to a heater associated with a catalytic converter of an exhaust of a vehicle. The plurality of energy storage units is configurable to provide power to the heater. The CMU is configured to determine a connection arrangement of two or more energy storage units of the plurality of energy storage units based on at least one parameter. The connection arrangement includes at least one connection type between the two or more energy storage units. The at least one parameter includes a temperature associated with the exhaust of the vehicle. The connection arrangement includes one of a first connection arrangement and a second connection arrangement. The first connection arrangement includes a first connection type. The second connection arrangement includes a second connection type. Determining the connection arrangement includes one of switching from the first connection arrangement to the second connection arrangement based on the at least one parameter and switching from the second connection arrangement to the first connection arrangement based on the at least one parameter. The CMU is further configured to cause the at least one switch to switch from a first switch state to a second switch state or from the second switch state to the first switch state based on the determined connection. The switching of the switch causes the two or more energy storage units to provide power to the vehicle using the determined connection arrangement.

According to another aspect, a method implemented in a CMU is described. The CMU is electrically connectable to a plurality of energy storage units configurable to provide power to a vehicle including an exhaust. The method includes determining a connection arrangement of two or more energy storage units of the plurality of energy storage units based on at least one parameter. The connection arrangement includes at least one connection type between the two or more energy storage units. The at least one parameter includes a temperature associated with the exhaust of the vehicle. The method further includes causing the two or more energy storage units to provide power to the vehicle using the determined connection arrangement.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 shows an example system (e.g., a connection management system) according to the principles of the present disclosure;

FIG. 2 shows a schematic diagram of an example connection management unit according to some embodiments of the present disclosure;

FIG. 3 shows an example connection arrangement of one or more energy storage units using a first switch type according to some embodiments of the present disclosure:

FIG. 4 shows another example connection arrangement of one or more energy storage units using a first switch type according to some embodiments of the present disclosure;

FIG. 5 shows an example connection arrangement of one or more energy storage units using a second switch type according to some embodiments of the present disclosure;

FIG. 6 shows another example connection arrangement of one or more energy storage units using a second switch type according to some embodiments of the present disclosure;

FIG. 7 shows another example system according to the principles of the present disclosure;

FIG. 8 shows an example method according to some embodiments of the present disclosure; and

FIG. 9 shows another example method according to some embodiments of the present disclosure.

### DETAILED DESCRIPTION

Before describing in detail exemplary embodiments, it is noted that the embodiments reside primarily in combinations of apparatus components and processing steps related to automatic switching of battery connections. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom.” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises.” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term. “in communication with” and the like, may be used to indicate electrical or data communication, which may be accomplished by physical contact, induction, electromagnetic radiation, signaling such as radio signaling, infrared signaling or optical signaling, etc. One having ordinary skill in the art will appreciate that multiple components may interoperate, and modifications and variations are possible of achieving the electrical and data communication.

In some embodiments described herein, the term “coupled.” “connected.” and the like, may be used herein to indicate a connection, although not necessarily directly, and may include wired and/or wireless connections and/or physical and/or electrical connections.

The term energy storage unit may refer to any element and/or component and/or system configured and/or arranged and/or capable to provide storage of energy such as a battery (e.g., a lead-acid battery, a lithium-ion battery), a battery cell, a battery subunit, a capacitor, etc. An energy storage unit may have one or more terminals, e.g., a positive terminal, a negative terminal.

The term “connection arrangement” used herein can be any kind of connection arrangement such as the arrangement of one or more connections (e.g., series, parallel, series-parallel, etc.) between energy storage units and/or terminals. The term parameter may refer to a parameter associated with the pre-start and/or operation of a vehicle and may comprise a voltage parameter (e.g., a voltage specification of a pre-heater or any other system), a current parameter (e.g., a current specification of a pre-heater), an environmental parameter (e.g., a parameter associated with the environment where the batteries/vehicle are located), a temperature parameter (e.g., a temperature threshold, air temperature of air surrounding a vehicle, temperature of a vehicle component (such as engine, exhaust, manifold, etc.), temperature of exhaust gasses, etc.), pressure parameter (e.g. pressure of a system/element associated with the vehicle), an operation mode (e.g., a pre-start mode, start mode, a post-start mode), a manual input (e.g., a selection made by a driver of truck to place the truck in pre-start and/or start modes), a system state (e.g., connected, disconnected, off, on, faulted, etc.), and/or any other parameter.

The term energy storage unit measurement may be a measurement of a parameter associated with an energy storage unit and/or a group of energy storage units such as voltage, current, temperature, pressure, energy storage unit health, etc. Further, the term switch may comprise at least one of a mechanical switch, electric switch, electro-mechanical switch, electronic switch such as a solid state switch, an automatic transfer switch, a switch having more than one state such as open, closed, in transition, etc. A switch may be any device/system configured to establish/terminate a connection, e.g., by using motion of parts such as arms that swing/rotate, by using electromagnetic switching such as relay switching, by using transistor switching, etc.

In some embodiment, the term “power a vehicle” is used and may refer to powering one or more components of the vehicle such as a heater, an engine starter, accessory systems, etc.

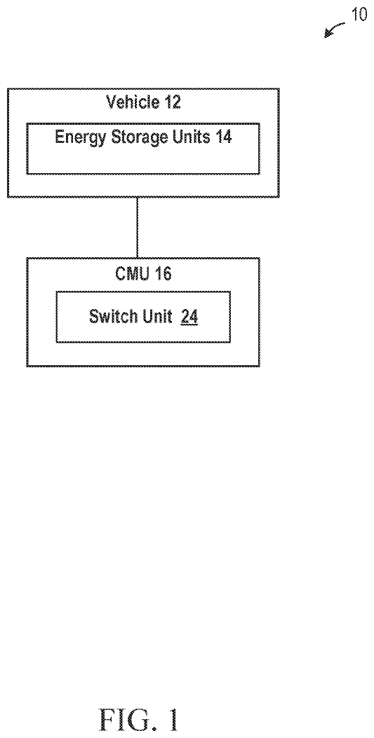

Referring now to the drawing figures, in which like elements are referred to by like reference numerals, there is shown in FIG. 1 an example system (e.g., a connection management system) according to the principles of the present disclosure. The connection management system (CMS) 10, according to an embodiment, comprises one or more vehicles 12 such as a motor-powered and/or electrically powered vehicle and/or a vehicle that is arranged to be pre-heated. The vehicle 12 comprises one or more energy storage units (ESU) 14 (e.g., batteries, battery pack, battery cells, etc.) for powering at least one function of vehicle 12. ESU 14 may be a lead-acid based battery and/or Li-Ion (lithium-ion) based battery that includes one or more energy storage modules. The teachings described herein are equally applicable to other battery types. CMS 10 may include at least one CMU 16 which may be standalone, included in ESU 14, included in vehicle 12, etc.

A CMU 16 includes a switch unit 18 configured to perform any step and/or task and/or method and/or process and/or feature described in the present disclosure, e.g., determine a connection arrangement of one or more energy storage units. CMU 16 and/or any of its components may also be configured to communicate with vehicle 12 and/or any component of vehicle 12 and/or other components and/or devices. The communication may be wireless communication, power communication, wired communication, etc.

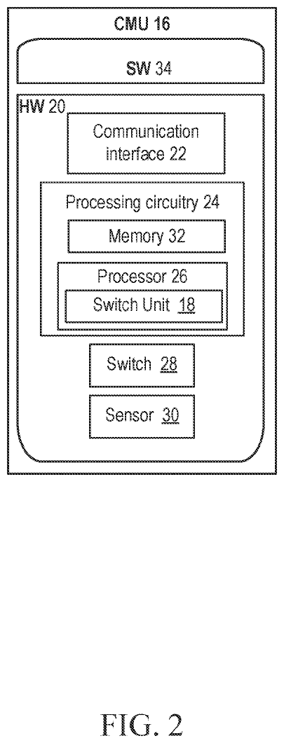

Example implementations, in accordance with an embodiment, CMU 16 discussed in the preceding paragraphs will now be described with reference to FIG. 2.

CMS 10 may include at least one CMU 16 already referred to. CMU 16 may have hardware 20 that may include a communication interface 22 that is configured to communicate with one or more entities in CMS 10 and/or of vehicle 12 via wired and/or wireless communication. The communication may be protocol-based communications, wired communications, and/or wireless communications, etc.

The hardware 20 includes processing circuitry 24. The processing circuitry 24 may include a processor 26 and memory 32. In particular, in addition to or instead of a processor, such as a central processing unit, and memory, the processing circuitry 24 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 26 may be configured to access (e.g., write to and/or read from) memory 32, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the CMU 16 may further comprise software (SW) 34, which is stored in, for example, memory 32, or stored in external memory (e.g., database, etc.) accessible by the CMU 16. The software 34 may be executable by the processing circuitry 24.

The processing circuitry 24 may be configured to control any of the methods and/or processes described herein and/or to cause such methods, and/or processes to be performed, e.g., by CMU 16. The processor 26 corresponds to one or more processors 26 for performing CMU 16 functions. CMU 16 includes memory 32 that is configured to store data, programmatic software code and/or other information described herein. In some embodiments, the software 34 may include instructions that, when executed by the processing circuitry 24 and/or processor 26, causes the processing circuitry 24 and/or processor 26 to perform the processes described herein at least with respect to CMU 16. For example, the processing circuitry 24 of CMU 16 may include switch unit 18 that is configured to perform one or more CMU 16 functions. Further. CMU 16 (e.g., included in hardware 20) may include at least one switch 28 configured to switch establish and terminate an electrical connection, e.g., between terminals of at least one ESU 14. Switch 28 may be configured to receive a signal (e.g., a trigger) to change a state such as to open (e.g., to terminate a connection) and/or close (e.g., to establish a connection). Switch 28 may be configured, such as via an embedded microcontroller, to transmit a signal (e.g., a state) to provide the state of the switch. In addition, CMU 16 may include sensor 30 (e.g., included in hardware 20) which may be configured perform at least one measurement, e.g., an energy storage unit measurement, parameters associated with vehicle, environment, and/or external devices/components. In some embodiments, CMU 16 may comprise/be a battery management system (BMS). Although switch 28 and sensor 30 are shown as being part of CMU 16 (e.g., included in hardware 20), switch 28 and/or sensor 30 are not limited as such, and switch 28 and/or sensor 30 may be included in any other component of CMU 16, be outside of CMU 16 such as a standalone switch 28 and/or standalone sensor 30, be part of another unit/device/system, etc. Switch 28 may be a mechanically operated switch, e.g., moved manually by an operator or by a motor, or may be an electronic switch, e.g., based on high-power capability semi-conductors and/or relays.

Although FIGS. 1 and 2 show various components including “units” such as switch unit 18, as being within a respective processor, it is contemplated that these units may be implemented such that a portion of the unit is stored in a corresponding memory within the processing circuitry. In other words, the units may be implemented in hardware, software or in a combination of hardware and software within the processing circuitry.

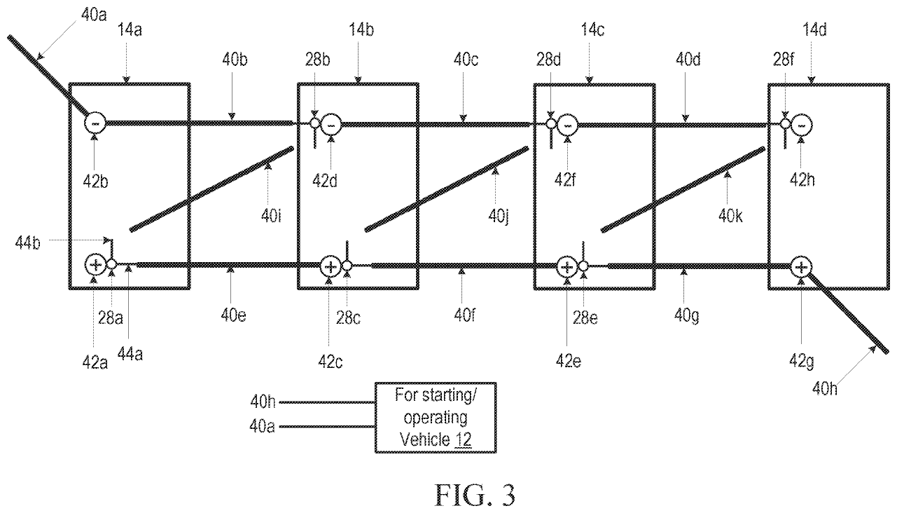

FIG. 3. shows an example connection arrangement of one or more energy storage units using a first switch type (switch including arms) according to some embodiments of the present disclosure. More specifically. ESUs 14 are connected using a connection arrangement (i.e., having a connection type such as a parallel connection using one or more connectors 40). ESUs 14a, 14b, 14c, 14d (collectively referred to as ESU 14) are included. Each ESU 14 includes one or more terminals 42. For example, ESU 14a includes terminal 42a and 42b, ESU 14b includes terminal 42c and 42d, ESU 14c includes terminal 42e and 42f, and ESU 14d includes terminal 42g and 42h. Further, each ESU 14 includes at least one switch 28. For example, ESU 4a includes switch 28a, ESU 14b includes switch 28b, 28c, ESU 14c includes switch 28d, 28e, ESU 14d includes switch 28f. Each switch 28 may be electrically connected to its corresponding terminal 42. Each switch 28 may include one or more arms 44 such as 44a, 44b on switch 28a. Switch 28 and/or arm 44 may be configured to establish and/or terminate a connection, e.g., by establishing/terminating electrical contact with connector 40 and/or terminal 42. Arms 44 may be configured to swing (i.e., rotate, move, sweep, etc.) and/or make physical/electrical contact with other objects such as connectors 40.

In this nonlimiting example, connectors 40 (e.g., a wire, cable, bus bar, etc.) and/or switches 28 are arranged to establish a parallel connection between ESUs 14. More specifically, connector 40a is connected to terminal 42b, which is connected to connector 40b. Connector 40b is connected to switch 28b which is connected to terminal 42d. Terminal 42d is connected to connector 40c which is connected to switch 28d. Switch 28d is connected to terminal 42f which is connected to connector 40d. Connector 40d is connected to switch 28f, which is connected to terminal 42h. In other words, each terminal 42b, 42d, 42f. 42h (e.g., each negative terminal) is connected (e.g., physically and/or electrically) to one or more terminals 42.

Similarly, terminal 42a is connected to switch 28a which is connected connector 40e. Connector 40e is connected to terminal 42c which is connected to switch 28c. Switch 28c is connected to connector 40f which is connected to terminal 42e. Terminal 42e is connected to switch 28e which is connected to connector 40g. Connector 40g is connected to terminal 42g which is connected to connector 40h. In other words, each terminal 42a, 42c, 42e, 42g (e.g., positive terminal) is connected (e.g., physically and/or electrically). By using the connection arrangement of this nonlimiting example, ESUs 14a, 14b, 14c, 14d (e.g., batteries) are connected in parallel. Connectors 40i, 40j, 40k are not connected. Connectors 40a, 40h may be used to provide power, e.g., for staring/operating vehicle 12. For example, each ESU may be arranged to provide 12V and, using the example connection arrangement, provide 12V in an electrically parallel circuit configuration. Other voltages may be also provided. In some embodiments, the connection arrangement of this nonlimiting example may refer to a primary operating mode.

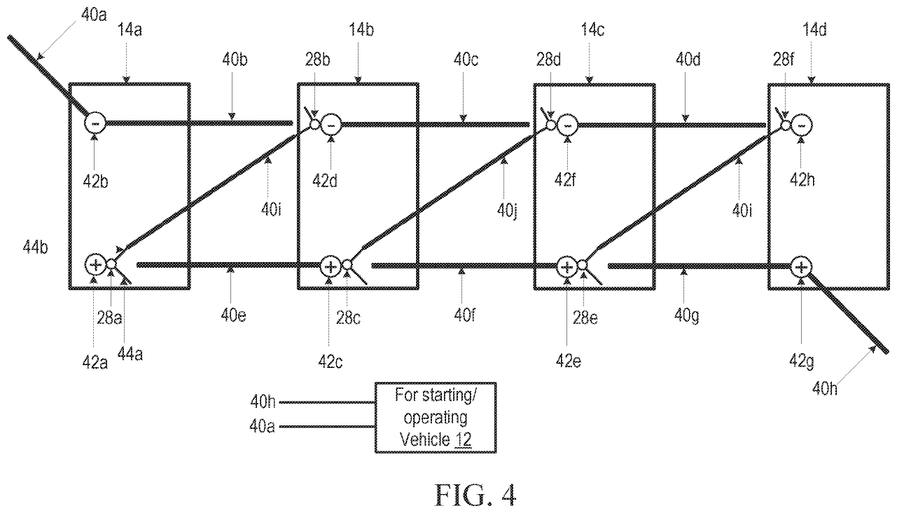

FIG. 4. shows an example connection arrangement of one or more energy storage units using a first switch type according to some embodiments of the present disclosure. More specifically, ESUs 14 are connected using a connection arrangement (i.e., having a connection type such as a series connection using one or more connectors 40). Each switch 28 has swinged arms 44 to terminate a connection arrangement (e.g., such as shown in FIG. 3) and/or establish another connection arrangement (e.g., series connection). In the non-limiting example shown, connector 40a is connected to terminal 42b, and terminal 42a is connected to switch 28a which is connected to connector 40i. Connector 40i is connected to switch 28b which is connected to terminal 42d. Terminal 42c is connected to switch 28c which is connected to connector 40j. Connector 40j is connected to switch 28d which is connected to terminal 42f. Terminal 42e is connected to switch 28e, which is connected to connector 40k. Connector 40k is connected to switch 28f, which is connected to terminal 42h. Terminal 42g is connected to connector 40h. Connectors 40b, 40c, 40d, 40e, 40f, 40g are disconnected (e.g., any connection to these connectors have been terminated).

In sum. ESUs 14 have been electrically connected in series (e.g., by using switches 28, in part by swinging arms 44 of switches 28, etc.). Connectors 40a, 40h may be used to provide power. e.g., for pre-start heat of vehicle 12. For example, each ESU 14 may be arranged to provide 12V, and ESUs 14a, 14b, 14c, 14b, using the example connection arrangement, to provide 48V (i.e., in series). Other voltages may be also provided. In some embodiments, the connection arrangement of this nonlimiting example may be referred to as a pre-start mode that may be used an electric catalyst heater. Thus, CMU 16 (and/or any of its components) may be configured to determine at least a connection arrangement and switch from one connection arrangement to another and/or vice versa (e.g., from the arrangement of FIG. 3 to the arrangement of FIG. 4 and vice versa).

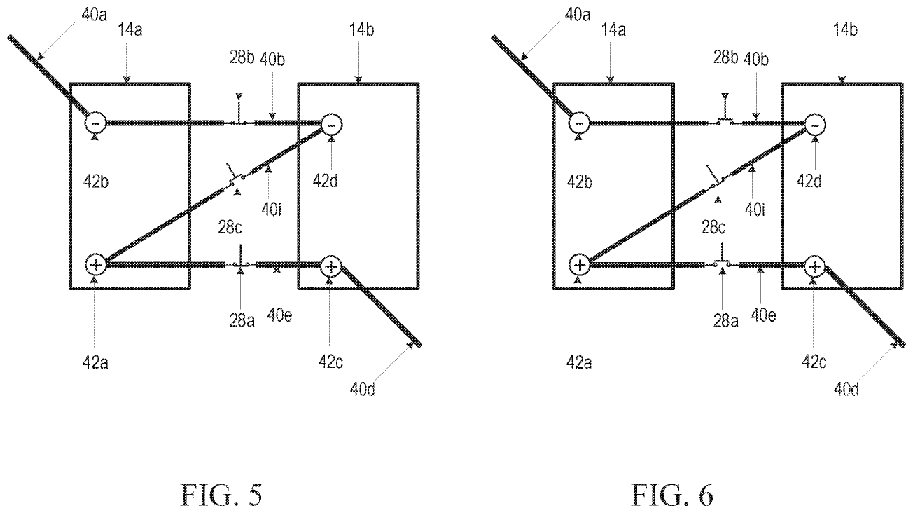

FIG. 5. shows an example connection arrangement of one or more energy storage units using a second switch type or second switch arrangement according to some embodiments of the present disclosure. The second switch type may be a switch 28 of a type that establishes and/or terminates a connection provided by connector 40, e.g., an electronic switch, which may be configured to receive a signal, e.g., from CMU 16 (and/or any of its components) and/or any other device, such as to trigger switch 28 to open/close to terminate/establish a connection on connector 40. In other words, switch 28 may be included in (and/or connected to) connector 40 such that when switch 28 opens any connection established by connector 40 is terminated and/or when switch 28 closes a connection is established (and/or is configured to be established) by connector 40. More specifically, terminals 42a and 42b are connected (i.e., via connector 40a and switch 28a in the closed position). Similarly, terminals 42b and 42d are connected (i.e., via connector 40b and switch 28b in the closed position). Terminals 42a and 42d are not connected to each other as connector 40c is interrupted by switch 28c which is open. In other words, ESUs 14a and 14b are connected in parallel and may be configured to provide together the voltage across terminals 42a-42b, 42c-42d.

FIG. 6. shows an example connection arrangement of one or more energy storage units using a second switch type according to some embodiments of the present disclosure. Switches 28a, 28b are in the open position, thereby terminating any connection provided by connectors 40a, 40b, respectively. However, switch 28c is closed, thereby establishing a connection between terminals 42a and 42d. Put differently, ESUs 14a and 14b are connected in an electrical series configuration, e.g., where the voltage across terminals 42b and 42c is the sum of the voltage across 42a-42b and the voltage across 42c-42d.

Although the examples of FIGS. 3 and 4 show four ESU 14 and FIGS. 5 and 6 show two ESU 14, the principles of the present invention are not limited as such and any other quantity of ESUs 14 may be used. In addition, although electrically series and parallel connections have been described with respect to FIGS. 3-6, any other connection arrangements may be determined and/or switched and/or used, e.g., series-parallel connections, groups of series, groups of parallel connections, groups of series-parallel connections, etc., based on the desired voltage and current requirements of the implementation. Further, although the first and second switch types have been described, any other switch types and/or switch arrangements may be used.

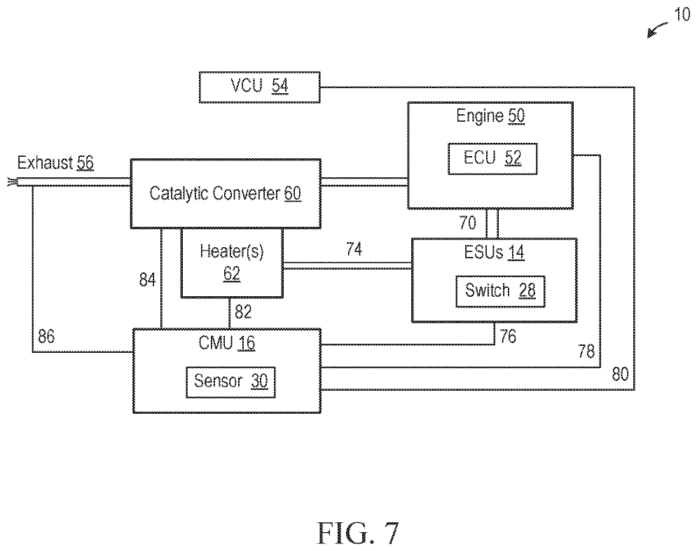

FIG. 7 shows an example CMS 10 according to some embodiments of the present disclosure. CMS 10 may include engine 50 (of vehicle 12) (which may include an engine control unit (ECU) 52), a vehicle control unit (VCU) 54, an exhaust 56, a catalytic converter 60 (of vehicle 12), one or more heaters 62. ECU 52 may be configured to monitor and control a vehicle engine. For example, ECU 52 may be configured to manage engine operation (e.g., receive inputs from various engine and/or vehicle components, make determinations, and produce outputs based on the determinations such as control actuators, valves, perform power management, etc.), and/or determine engine parameters (e.g., cranking information, fuel flow information, fuel management parameters, starter motor information and parameters, etc.) and/or transmit/receive signaling including information associated with any ECU functions and/or VCU functions and/or CMU functions and any other component functions. In a nonlimiting example, ECU 52 is configured to control engine operation and/or receive signals from CMU 16 indicating that a connection arrangement corresponding to engine start has been selected and/or enable engine starting based one the received signals.

VCU 54 may be configured to control/monitor accessory systems and/or provide information to the driver of vehicle 12 (and/or cause the information to be displayed) such as to provide status information associated with components of vehicle 12 and other functions associated with CMS 10 including CMU 16 and ESUs 14. VCU 54 may also be configured to receive inputs (e.g., ignition key position, selection of connection arrangement mode such as automatic, semi-automatic, manual, etc.) and/or transmit/receive signals to/from CMU 16 and/or ECU 52 including information associated with VCU functions and/or CMU functions and/or ECU functions and/or any other component functions. In a nonlimiting example, VCU 54 is configured to display information associated with a catalytic converter and/or heater and/or connection arrangement, and/or receive inputs from the driver to select a connection arrangement (and/or a connection arrangement mode).

Further, CMS 10 may include ESUs 14 (e.g., batteries) and CMU 16, which may include sensor 30 and switch 28 (e.g., located in ESUs 14). Engine 50 may be coupled to the exhaust 56 such that when engine 50 is started and/or operated gases from the combustion are directed away from the engine 50 (and/or vehicle 12). Catalytic converter 60 may be part of exhaust 56 (e.g., where gases of exhaust 56 pass through the catalytic converter 60). Catalytic converter 60 may be coupled to or in proximity to heater 62.

Electrical power may be provided to Engine 50 (e.g., starter, ignition, etc.) by ESU 14 via electrical connection 70. Further, ESU 14 may provide electrical power to any other component of CMS 10 such as heater 62 via electrical connection 74. Although other electrical connections are not shown, ESU 14 may also provide power to VCU 54, CMU 16, etc.

CMU 16 may also be configured to communicate with ESUs 14 (e.g., switch 28) via communication link 76 such as to cause switch 28 to switch a connection arrangement, receive switch status information, connection arrangement information. ESUs parameters (e.g., voltage, current, state of charge, state of health, etc.). CMU 16 may also communicate with engine 50 (and/or ECU 52) via communication link 78 such as to receive engine information. CMU 16 may also communicate with VCU 54 via communication link 80 such as to receive and/or transmit information associated with vehicle systems (e.g., accessories, ignition switch status, inputs from the driver, information associated with heater 62, information associated with catalytic converter 60 etc.). Further, CMU 16 may be electrically connected via electrical connection 82 to heater 62 (e.g., to provide power to heater 62) and/or to catalytic converter 60 via communication link 84 to measure a parameter associated with the catalytic converter 60 such as temperature, status, gas presence, etc. In addition, parameters associated with exhaust 56 (e.g., exhaust gas temperature) may be measured by CMU 16 via communication link 86 Sensor 30 may be configured to sense one or more parameters via communication links and/or electrical connections. Communication links may refer to data and/or electrical links/connections.

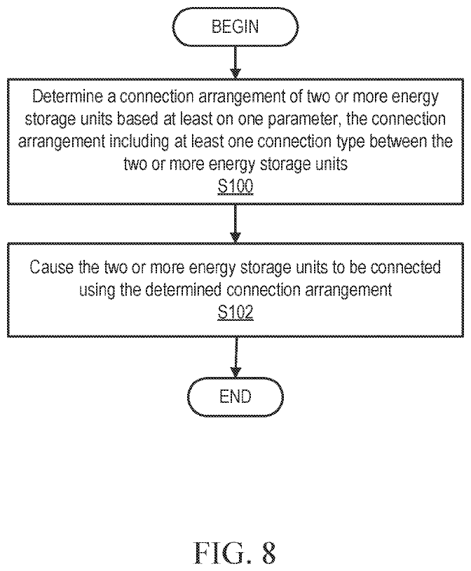

FIG. 8 is a flowchart of an example process in a CMU 16 (and/or CMS 10) according to the principles of the present disclosure. One or more blocks described herein may be performed by one or more elements of CMU 16 such as by one or more of processing circuitry 24 (including the switch unit 18), processor 26, and/or communication interface 22. CMU 16 such as via processing circuitry 24 and/or processor 26 and/or communication interface 22 is configured to determine (Block S100) a connection arrangement of two or more energy storage units 14 based at least on one parameter, where the connection arrangement includes at least one connection type between the two or more energy storage units 14; and cause (Block S102) the two or more energy storage units 14 to be connected using the determined connection arrangement.

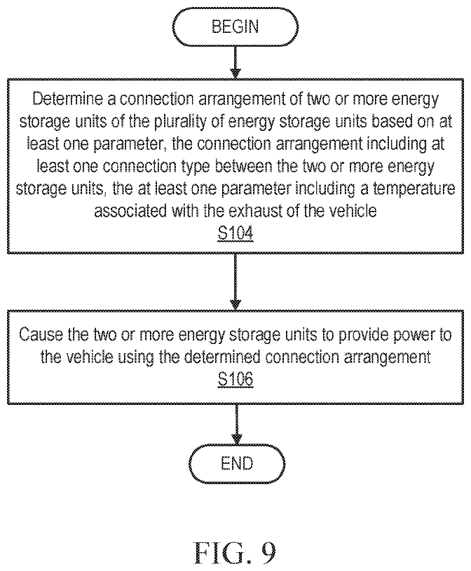

FIG. 9 is a flowchart of another example process in a CMU 16 (and/or CMS 10) according to the principles of the present disclosure. One or more blocks described herein may be performed by one or more elements of CMU 16 such as by one or more of processing circuitry 24 (including the switch unit 18), processor 26, and/or communication interface 22 and/or switch 28 and/or sensor 30. CMU 16 such as via processing circuitry 24 and/or processor 26 and/or communication interface 22 is configured to determine (Block S104) a connection arrangement of two or more energy storage units 14 of the plurality of energy storage units 14 based on at least one parameter. The connection arrangement includes at least one connection type between the two or more energy storage units 14. The at least one parameter includes a temperature associated with the exhaust 56 of the vehicle 12. The CMU is further configured to cause (Block S106) the two or more energy storage units 14 to provide power to the vehicle 12 using the determined connection arrangement.

In some embodiments, the at least one connection type includes any one of an electrically series connection, an electrically parallel connection, and an electrically parallel-series connection.

In some other embodiments, the at least one parameter further includes at least one of a voltage parameter, a current parameter, an environmental parameter, another temperature parameter, a pressure parameter, an operation mode, a manual input, and a system state.

In some embodiments, the connection arrangement includes one of a first connection arrangement and a second connection arrangement. The first connection arrangement includes a first connection type, and the second connection arrangement includes a second connection type.

In some other embodiments, determining the connection arrangement includes one of switching from the first connection arrangement to the second connection arrangement based on the at least one parameter and switching from the second connection arrangement to the first connection arrangement based on the at least one parameter.

In some embodiments, the CMU further includes at least one switch 28, and the method further includes to one or more of establishing, maintaining and terminating, via the switch 28, an electrical connection corresponding to the at least one connection type at least between the two or more energy storage units 14 based on the determined connection arrangement.

In some other embodiments, the method further includes determining at least one energy storage unit measurement and determining a connection state associated with the at least one connection type based on the determined at least one energy storage unit measurement.

In some embodiments, the determined connection state includes at least one of a successful connection and a faulted connection of the two or more energy storage units 14.

In some other embodiments, the method further includes one or both of receive the at least one parameter from one or both of the vehicle 12 and an energy storage unit management system (e.g., a BMS) and transmit information associated with at least one of the connection arrangement, one or more energy storage units 14 of the plurality of energy storage units 14, the at least one parameter, and the at least one connection type.

In some embodiments, the method further includes determining a demand associated with at least one energy storage unit of the plurality of energy storage units 14 based the at least one parameter. The demand is usable for one or both of determining the connection arrangement and causing the two or more energy storage units 14 to provide power to the vehicle 12 using the determined connection arrangement.

In some other embodiments, the method further includes forecasting the demand based on a plurality of values through time corresponding to the at least one parameter.

In some embodiments, the method further includes determining a profile usable to determine the connection arrangement and provide power to a vehicle component (e.g., heater 62 of catalytic converter 60, starter of engine 50, VCU 54, or other components). The profile being determined based on a vehicle component parameter and the at least one parameter.

In some other embodiments, the profile includes information usable by the CMU to cause the two or more energy storage units 14 to one of increase, maintain, decrease, terminate the power provided to the vehicle component.

Having described the general process flow of arrangements of the disclosure and having provided examples of hardware and software arrangements for implementing the processes and functions of the disclosure, the sections below provide details and examples of arrangements for automatic battery connection switching.

In some embodiments, one or more switches 28 may be integrated for one or more ESUs 14 to switch from a first connection arrangement to a second connection arrangement when a power profile is met (and/or exceeded). In some other embodiments, one or more switches 28 are automatic transfer switches. In one embodiment, ESUs 14 are lead acid batteries. In another embodiment, the first connection arrangement includes an electrical parallel connection (i.e., a first connection type), and the second connection arrangement includes an electrical series connection (i.e., a second connection type). In some embodiments, switching from a first connection arrangement to a second connection arrangement is triggered when the profile (e.g., a high power 48V profile) is required/exceeded. Switching from the second connection arrangement to the first connection arrangement is triggered when the profile is not required/exceeded such as when a 12V in parallel can be used. In some other embodiments, a high-power profile is associated with powering a 48V electric catalyst heater. In one or more embodiments, a connection arrangement may include one or more connection types (i.e., series connection, parallel connection, a combination thereof). In some embodiments, a connection type may refer to a connection arrangement.

In some other embodiments, additional power is required to support an electric catalyst heater application, e.g., in commercial trucks. In one or more embodiments, a 12V battery (e.g., where a single 12V battery is used) may not have enough power to support a heater 62 (e.g., pre-heater). Other batteries such as 48V lithium-ion batteries may be used in a closed loop system to support the application needs. In one embodiment, by leveraging four batteries (e.g., ESUs 14 in FIGS. 3 and 4) in an electrical series arrangement (e.g., after switching from a parallel connection), the system (i.e., CMS 10, CMU 16) may provide power (e.g., may have sufficient power) to support a heater 62 (e.g., an electric catalyst heater) at pre-heat. After the pre-heat is complete, the batteries may be switched back to normal operation in a parallel configuration.

In a nonlimiting example, a system such as a CMS 10, which may include vehicle 12 (e.g., a commercial truck) and a CMU 16 configured to determine a connection arrangement of two or more ESUs 14 (e.g., lead-acid batteries). The connection arrangement may include more than one connection arrangement of the ESUs 14 such as a parallel connection, a series connection, and/or a combination thereof. Vehicle 12 may include a heater which may be used in environments where the environment temperature is below a predetermined threshold. The heater 62 may be arranged to transform electrical energy (e.g., provided using 48V) into heat. Further, vehicle 12 may include one or more systems that are electrically powered using a predetermined voltage such as 12V.

Vehicle 12 (and/or CMU 16 and/or VCU 54 and/or CMS 10) may include a selector switch including one or more options for selection, such as automatic switching, manual switching, etc. The selection may be a manual input that can be received/determined by CMU 16, e.g., to determine the connection arrangement. When automatic switching is selected, CMU 16 may automatically perform the connection arrangement determination and/or switch to the determined connection arrangement based at least in part on the manual input being automatic switching. In addition, automatic switching may be performed based on other parameters such as a voltage parameter (e.g., 48V requirement of pre-heat), a measured vehicle exhaust temperature, a measured environment temperature, a mode of operation of vehicle 12, a system state such as degraded, faulted, normal, low-energy, battery state, etc.

Further, manual switching may include parallel switching and series switching options. When in manual switching, CMU 16 may perform the connection arrangement determination and/or switch to the determined connection arrangement based at least in part on whether the manual input is parallel switching or series switching.

Although a selector switch may be used, a selector switch is not required. CMU 16 may be configured to determine a connection arrangement and/or switch (e.g., cause ESUs 14 to be connected using the determined connection arrangement) by itself (i.e., without using a selector switch). For example, CMU 16 may be configured to automatically switch from a series connection to a parallel connection to power a pre-heater when the temperature outside vehicle 12 is lower than a predetermined threshold and/or the engine of vehicle 12 has not started.

Further. CMU 16 may be configured to determine a connection state (e.g., whether a switched connection arrangement is successful, unsuccessful, in transition, delayed, etc.). For example, CMU 16 may be configured to determine whether a connection arrangement has successfully been switched based on a measurement (e.g., an ESU measurement such as voltage across terminals). More specifically, a parallel connection may be determined to be successful when 12V (+/−a predetermined tolerance) is measured/read, by CMU 16, across connectors 40a and 40h of FIG. 3. Similarly, a series connection may be determined to be successful when 48V (+/−a predetermined tolerance) is measured/read, by CMU 16, across connectors 40a and 40h of FIG. 4.

Switch 28 may be configured to transmit/provide a switch connection state such as open, closed, connected, disconnected, in transition, faulted, etc. CMU 16 may use the switch connection state to determine the connection state. For example, a switch 28a may indicate a switch connection state such as faulted/disconnected. A faulted/disconnected state may indicate that the connection is unsuccessful such as where 28a in FIG. 5 is disconnected and/or not responding and/or not communication where the parallel connection is not achieved. Any other measurement/parameter may be used to determine a connection state, a connection arrangement, etc. In addition, CMU 16 may be configured to transmit/receive, to/from vehicle 12, any information associated with at least one of the at least one energy storage unit parameter, the connection state, and the connection arrangement, e.g., transmit information about a connection state being successful/unsuccessful. The transmitted information may be displayed on a vehicle display and/or used by vehicle 12 to perform one or more functions.

In a nonlimiting example, vehicle 12 is equipped with an internal combustion engine 50 which generates gases when the engine 50 is started and/or operated and/or during engine shutdown. In these implementations, the vehicle 12 is also equipped with an exhaust system (i.e., exhaust 56) that is arranged to direct the gases away from the engine 50. The gases may be referred to as emissions, which may contain toxic gases, pollutants, etc. Vehicle operators may be required to comply with regulation of exhaust emissions. A catalytic converter 60 may be arranged to reduce the amount toxic gases, pollutants, etc. emitted by the engine. Therefore, a vehicle 12 may also be equipped with a catalytic converter 60 to reduce emissions. However, at least some catalytic converters 60 are effective at reducing emissions when operated within a predetermined temperature range. For example, some catalytic converters 60 may not be effective at reducing emissions during cold starts, e.g., in a way that complies with required regulations. A cold start may refer to an engine start event that occurs or is attempted when the temperature of the engine 50 and/or environment and/or catalytic converter 60 and/or vehicle 12 and/or any other component is within a predetermined temperature range or below a predetermined temperature. The vehicle 12 may be further equipped with a heater 62 arranged to receive electrical power (e.g., from one or more ESUs 14) and heat the catalytic converter 60.

CMU 16 may be configured to perform one or more measurements and determinations. More specifically. CMU 16 may be configured to measure temperature such as temperature of the environment where the vehicle is located (and/or obtain weather information including temperature). CMU 16 may be configured to measure temperature of the exhaust gasses (or emissions) and/or temperature of the exhaust system (e.g., in one or more zones of the exhaust system) and/or temperature of the catalytic converter and/or temperature of the engine and/or engine compartment and/or temperature in the engine induction system (e.g., temperature of air before being mixed with fuel). Any of the temperature measurements may be used by CMU 16 to determine whether and/or when the catalyst converter 60 is to be heated and/or for how long.

When the driver the vehicle 12 is ready to start the engine. e.g., the driver changes the position of the ignition key to any mode other than off. CMU 16 being in communication with vehicle 12 obtains information about the mode (e.g., accessory, on, start, etc.) such as via VCU 54 and/or ECU 52. Based on the information and any of the temperature measurements performed, CMU 16 may determine a first connection arrangement (e.g., series) such that a voltage (e.g., 48V) is provided by ESUs 14 to the heater 62. CMU 16 causes the ESUs 14 to switch to the first connection arrangement and electrically connect to the heater 62. The heater 62 provides heat to the catalytic converter for a predetermined period of time and/or until a temperature (e.g., of the catalytic converter) reaches or exceeds a predetermined threshold. Then. CMU 16 causes the ESUs 14 to switch to a second connection arrangement (e.g., parallel) to provide power to the engine starter and/or cause the vehicle 12 to display an indication via VCU that catalytic converter 60 has been heated and the vehicle 12 is ready to be started.

Further, CMU 16 may be configured to determine (and/or forecast) a demand associated with the ESUs 14 and/or vehicle 12 (and/or vehicle systems such as catalytic converter, engine, etc.). The demand may be determined and/or forecasted and/or anticipated based on measurements and/or parameters. The demand may refer to a power parameter (e.g., voltage parameter such as voltage range, current parameter such as current range, etc.). The demand may be anticipated and/or forecasted using a learning process that receives a plurality of values corresponding to the parameters and/or measurements.

In another nonlimiting example, vehicle 12 is turned off for period of time (e.g., 5 minutes), CMU 16 may be configured to measure the temperature of the catalyst converter 60 and determine that the catalytic converter 60 does not need to be heated before restarting the engine.

In one nonlimiting example, CMU 16 determines that a heating profile which is usable by CMU 16 to determine the time that the catalyst converter is to be heated and/or voltage provided. The heating profile may include a plurality of cases, where a combination of time and voltage may be obtained for each case. For example, if the vehicle 12 has been off for a period of time (Vt_off) that exceeds a first threshold (e.g., 24 hours), the profile includes a first case where the catalytic converter is to be heated for a first period of time (Ht_on1). If vehicle 12 has been off for Vt_off that is less the first threshold, the profile includes a second case where the catalytic converter is to be heated for a second period of time (Ht_on2). Other cases may be added.

Further, the heating of the catalyst converter 60 may be ramped up or down. For example, a different voltage and/or current may be provided to heat up faster than a default case. Where more than one heater 62 (or heating element) is present, CMU 16 may be configured to provide electrical connections 82 to one or more heaters 62. CMU 16 may be configured to provide voltage to one heater first, then to two heaters (e.g., such as to ramp up heating), and then to one heater (e.g., to ramp down heating). The ramping up and/or down may be determined based on the profile, cases of the profile, information of the profile, measurements made by CMU 16 (e.g., such as temperature), manual inputs by the vehicle operator (e.g., signaled to CMU 16), etc.

In one nonlimiting example, vehicle 12 (e.g., VCU 54, ECU 52, etc.) may transmit a signal to CMU 16. The signal may include an indication indicating what voltage is needed and/or connection arrangement to switch to and/or a start event is going to occur.

In some other embodiments, switching to a connection arrangement is performed to connect ESUs 14 to at least another ESU (battery) and/or an auxiliary system of vehicle 12. For example, instead of powering auxiliary systems by running the engine 50, the connection arrangement of ESUs 14 may be switched to provide power to auxiliary systems (e.g., in addition to other batteries) while vehicle 12 is parked overnight.

In some embodiments, switching to a connection arrangement is performed based on additional information such as specification information associated with catalytic converter 60, heater 62, vehicle 12, route information, vehicle operator preferences, etc.

In some other embodiments, CMU 16 may be configured to cause ESUs 14 to change from a first connection arrangement to a second connection arrangement. CMU 16 is further configured to determine an intermediate connection arrangement. The third connection arrangement (e.g., an intermediate connection arrangement) may allow ESUs 14 to provide power to one or more components of CMS 10 between the time that a switch occurs between the first connection arrangement and the second connection arrangement and vice versa. The third connection arrangement may refer to using at least a subset of an entire subset of ESUs 14 to power one or more components. Further, CMU 16 may be configured to determine a fourth connection arrangement usable for powering one or more components while one or more connection arrangements are in use. For example, while two or more ESUs 14 are connected using a second connection arrangement (e.g., series) to heat heater 62, two or more ESUs 14 may be connected using a fourth connection arrangement (parallel) to power other components of vehicle 12 (e.g., accessories). In some embodiments, a fifth connection arrangement may refer to a combination of connection arrangements and groups of ESUs 14, where each group of ESU 14 has a corresponding connection arrangement.

The following is a nonlimiting list of example embodiments.

Embodiment A1. A connection management unit, CMU, the CMU being electrically connectable to at least one energy storage unit, the CMU being configured to, and/or comprising a communication interface and/or comprising processing circuitry configured to:
determine a connection arrangement of two or more energy storage units based at least on one parameter, the connection arrangement including at least one connection type between the two or more energy storage units.

Embodiment A2. The CMU of Embodiment A1, wherein the at least one connection type includes any one of an electrically series connection, an electrically parallel connection, and an electrically parallel-series connection.

Embodiment A3. The CMU of any one of Embodiments A1 and A2, wherein the at least one parameter includes at least one of a voltage parameter, a current parameter, an environmental parameter, a temperature parameter, pressure parameter, an operation mode, a manual input, and a system state.

Embodiment A4. The CMU of any one of Embodiments A1-A3, wherein the CMU further includes at least one switch configured to any one of establish and terminate an electrical connection based on the determined connection arrangement.

Embodiment A5. The CMU of any one of Embodiments A1-A4, wherein the processing circuitry is further configured to:
determine at least one energy storage unit measurement; and
determine a connection state based on the determined at least one energy storage unit measurement.

Embodiment A6. The CMU of Embodiment A5, wherein the determined connection state includes at least one of a successful connection and a faulted connection.

Embodiment A7. The CMU of any one of Embodiments A5 and A6, wherein the communication interface is configured to at least one of:
receive the at least one parameter; and
transmit information associated with at least one of the at least one energy storage unit measurement, the connection state, and the connection arrangement.

Embodiment A8. The CMU of any one of Embodiments A1-A7, wherein determining the connection arrangement causes the two or more energy storage units to be connected using the determined connection arrangement.

Embodiment B1. A connection management system, CMS, the CMS comprising:
a plurality of energy storage units;
a connection management unit, CMU, the CMU being electrically connectable to at least one energy storage unit of the plurality of energy storage units, the CMU being configured to, and/or comprising a communication interface and/or comprising processing circuitry configured to:
   determine a connection arrangement of two or more energy storage units based at least on one parameter, the connection arrangement including at least one connection type between the two or more energy storage units; and
   cause the two or more energy storage units to be connected using the determined connection arrangement.

Embodiment B2. The CMS of Embodiment B1, wherein the at least one connection type includes any one of an electrically series connection between the two or more energy storage units, an electrically parallel connection between the two or more energy storage units, and an electrically parallel-series connection using at least three energy storage units.

Embodiment B3. The CMS of any one of Embodiments B1 and B2, wherein the at least one parameter includes at least one of a voltage parameter, a current parameter, an environmental parameter, a temperature parameter, pressure parameter, an operation mode, a manual input, and a system state.

Embodiment B4. The CMS of any one of Embodiments B1-B3, wherein:
the plurality of energy storage units include:
   a first energy storage unit having a first terminal and a second terminal; and
   a second storage unit having a third terminal and a fourth terminal;
the CMU further includes:
   at least one switch configured to any one of establish and terminate an electrical connection, based on the determined connection arrangement, between any one of:
      the first terminal and any one of the third terminal and fourth terminal; and
      the second terminal and any one of the third terminal and fourth terminal.

Embodiment B5. The CMS of any one of Embodiments B1-B4, wherein the processing circuitry is further configured to:
determine at least one energy storage unit measurement associated with at least one energy storage unit of the plurality of energy storage units; and
determine a connection state based on the determined at least one energy storage unit measurement.

Embodiment B6. The CMS of Embodiment B5, wherein the determined connection state includes at least one of a successful connection and a faulted connection.

Embodiment B7. The CMS of any one of Embodiments B5 and B6, wherein the communication interface is configured to at least one of:
receive the at least one parameter; and
transmit information associated with at least one of the at least one energy storage unit measurement, the connection state, and the connection arrangement.

Embodiment C1. A method comprising:
determining a connection arrangement of two or more energy storage units based at least on one parameter, the connection arrangement including at least one connection type between the two or more energy storage units; and
causing the two or more energy storage units to be connected using the determined connection arrangement.

Embodiment C2. The method of Embodiment C1, wherein the method further includes:
one of establishing and terminating an electrical connection, based on the determined connection arrangement, between the two or more energy storage units

Embodiment C3. The method of any one of Embodiments C1 and C2, wherein the method further includes:
determining at least one energy storage unit measurement associated with at least one energy storage unit of the plurality of energy storage units; and
determining a connection state based on the determined at least one energy storage unit measurement.

Embodiment C4. The method of Embodiments C3, wherein the method further includes:
transmitting information associated with at least one of the at least one energy storage unit parameter, the connection state, and the connection arrangement.

Embodiment C5. The method of any one of Embodiments C1-C4, wherein the method further includes:
receiving the at least one parameter.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks. CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python. Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings and/or following claims.

1. A connection management unit, CMU, the CMU being electrically connectable to a plurality of energy storage units configurable to provide power to a vehicle including an exhaust, the CMU being configured to:
determine a connection arrangement of two or more energy storage units of the plurality of energy storage units based on at least one parameter, the connection arrangement including at least one connection type between the two or more energy storage units, the at least one parameter including a temperature associated with the exhaust of the vehicle; and
cause the two or more energy storage units to provide power to the vehicle using the determined connection arrangement.

2. The CMU of claim 1, wherein the at least one connection type includes any one of an electrically series connection, an electrically parallel connection, and an electrically parallel-series connection.

3. The CMU of claim 1, wherein the at least one parameter further includes at least one of:
a voltage parameter;
a current parameter;
an environmental parameter;
another temperature parameter;
a pressure parameter;
an operation mode;
a manual input; and
a system state.

4. The CMU of claim 1, wherein the connection arrangement includes one of a first connection arrangement and a second connection arrangement, the first connection arrangement including a first connection type, the second connection arrangement including a second connection type.

5. The CMU of claim 4, wherein determining the connection arrangement includes one of:
switching from the first connection arrangement to the second connection arrangement based on the at least one parameter; and
switching from the second connection arrangement to the first connection arrangement based on the at least one parameter.

6. The CMU of claim 1, wherein the CMU further includes at least one switch configured to one or more of:
establish, maintain and terminate an electrical connection corresponding to the at least one connection type at least between the two or more energy storage units based on the determined connection arrangement.

7. The CMU of claim 1, wherein the CMU is further configured to:
determine at least one energy storage unit measurement; and
determine a connection state associated with the at least one connection type based on the determined at least one energy storage unit measurement.

8. The CMU of claim 7, wherein the determined connection state includes at least one of a successful connection and a faulted connection of the two or more energy storage units.

9. The CMU of claim 1, wherein the CMU further includes a communication interface configured to one or both of:
receive the at least one parameter from one or both of the vehicle and an energy storage unit management system; and
transmit information associated with at least one of the connection arrangement, one or more energy storage units of the plurality of energy storage units, the at least one parameter, and the at least one connection type.

10. The CMU of claim 1, wherein the CMU is further configured to:
determine a demand associated with at least one energy storage unit of the plurality of energy storage units based the at least one parameter, the demand being usable for one or both of determining the connection arrangement and causing the two or more energy storage units to provide power to the vehicle using the determined connection arrangement.

11. The CMU of claim 10, wherein the CMU is further configured to:
forecast the demand based on a plurality of values through time corresponding to the at least one parameter.

12. The CMU of claim 1, wherein the CMU is further configured to:
determine a profile usable to determine the connection arrangement and provide power to a vehicle component, the profile being determined based on a vehicle component parameter and the at least one parameter.

13. The CMU of claim 12, wherein the profile includes information usable by the CMU to cause the two or more energy storage units to one of increase, maintain, decrease, terminate the power provided to the vehicle component.

14. A connection management unit, CMU, the CMU being electrically connectable to a plurality of energy storage units configurable to provide power to a vehicle including an exhaust, the CMU being configured to:
determine a connection arrangement of two or more energy storage units of the plurality of energy storage units based on at least one parameter, the connection arrangement including at least one connection type between the two or more energy storage units, the at least one parameter including a temperature associated with the exhaust of the vehicle, the connection arrangement including one of a first connection arrangement and a second connection arrangement, the first connection arrangement including a first connection type, the second connection arrangement including a second connection type, determining the connection arrangement including one of:
switching from the first connection arrangement to the second connection arrangement based on the at least one parameter; and
switching from the second connection arrangement to the first connection arrangement based on the at least one parameter; and
cause the two or more energy storage units to one of provide power and terminate providing power to the vehicle using the determined connection arrangement.

15. The CMU of claim 14, wherein the CMU further includes at least one switch configured to one or more of:
establish, maintain and terminate an electrical connection corresponding to the at least one connection type at least between the two or more energy storage units based on the determined connection arrangement.

16. The CMU of claim 14, wherein the CMU is further configured to:
determine a demand associated with at least one energy storage unit of the plurality of energy storage units based the at least one parameter, the demand being usable for one or both of determining the connection arrangement and causing the two or more energy storage units to provide power to the vehicle using the determined connection arrangement.

17. The CMU of claim 16, wherein the CMU is further configured to:
forecast the demand based on a plurality of values through time corresponding to the at least one parameter.

18. The CMU of claim 14, wherein the CMU is further configured to:
determine a profile usable to determine the connection arrangement and provide power to a vehicle component, the profile being determined based on a vehicle component parameter and the at least one parameter.

19. The CMU of claim 18, wherein the profile includes information usable by the CMU to cause the two or more energy storage units to one of increase, maintain, decrease, terminate the power provided to the vehicle component.

20. A system comprising a connection management unit, CMU, and a plurality of energy storage units, the CMU comprising at least one switch electrically connectable to at least one of the plurality of energy storage units, the CMU being electrically connectable to the plurality of energy storage units, the plurality of energy storage units being electrically connectable to a heater associated with a catalytic converter of an exhaust of a vehicle, the plurality of energy storage units being configurable to provide power to the heater:
the CMU being configured to:
determine a connection arrangement of two or more energy storage units of the plurality of energy storage units based on at least one parameter, the connection arrangement including at least one connection type between the two or more energy storage units, the at least one parameter including a temperature associated with the exhaust of the vehicle, the connection arrangement including one of a first connection arrangement and a second connection arrangement, the first connection arrangement including a first connection type, the second connection arrangement including a second connection type, determining the connection arrangement including one of:
switching from the first connection arrangement to the second connection arrangement based on the at least one parameter; and
switching from the second connection arrangement to the first connection arrangement based on the at least one parameter; and
cause the at least one switch to switch from a first switch state to a second switch state or from the second switch state to the first switch state based on the determined connection, the switching of the switch causing the two or more energy storage units to provide power to the vehicle using the determined connection arrangement.

21. (canceled)
